(19) United States
(12) Patent Application Publication
(10) Pub. No.: US 2005/0188068 A1
(43) Pub. Date: Aug. 25, 2005

(54) System and method for monitoring and controlling server nodes contained within a clustered environment

(76) Inventor: Frank Kilian, Mannheim (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,543

(22) Filed: Dec. 30, 2003

(51) Int. Cl. G06F 15/173

(52) U.S. Cl. 709/223

(57) ABSTRACT

A system and a corresponding method for monitoring and controlling server nodes in a clustered environment. The cluster includes a first instance and a second instance, each of the first and second instances including a number of server nodes. Each instance executes a control logic to start the instance by initiating a launch logic for each of the server nodes in the cluster. When initiated, the launch logic is configured to load a virtual machine in each respective server node and execute Java processes in the virtual machine. The system further includes a communication interface coupled between the launch logic and the control logic to enable exchange of information between the Java processes and the control logic. The launch logic is configured to obtain information regarding a status of each of the Java processes running in the virtual machine and enable the control logic to access the status information via the communication interface.

### BACKGROUND

1. Field

Embodiments of the invention relate to a system and method for monitoring and controlling server nodes contained within a clustered environment.

2. Background

A clustered system may include a collection of server nodes and other components that are arranged to cooperatively perform computer-implemented tasks, such as providing client computers with access to a set of services and resources. A clustered system may be used in an enterprise software environment to handle a number of tasks in parallel. Typically, load balancing algorithm is implemented within the clustered system to distribute incoming requests from the client computers evenly among multiple server nodes. In some cases, a single server node in the clustered system may handle requests from a client computer. In other cases, the requests received from a client computer may be handled by more than one server node cooperating with one another to perform the requested tasks. If a process executed within a server node of a clustered system fails during processing of a client request, there is a need for a control mechanism that is capable of realizing that a failure has occurred and to enable the same server node or a different server node to assume the operations of the failed process.

### SUMMARY

In accordance with one embodiment of the invention, a system and a corresponding method are disclosed for monitoring and controlling server nodes contained within a clustered environment. The cluster includes a first instance and a second instance, each of the first and second instances including a number of server nodes. The system includes a control logic to, among other things, start the cluster by initiating a launch logic for each of the server nodes contained in the first and second instances. When initiated, the launch logic is configured to load a virtual machine in each respective server node and execute Java processes in the virtual machine. The system further includes a communication interface coupled between the launch logic and the control logic to enable exchange of information between the Java processes and the control logic. The launch logic is configured to obtain information regarding a status of each of the Java processes running in the virtual machine and enable the control logic to access the status information via the communication interface.

### BRIEF DESCRIPTION OF THE DRAWINGS

The invention is illustrated by way of example and not by way of limitation in the figures of the accompanying drawings in which like references indicate similar elements. It should be noted that the references to “an” or “one” embodiment of this disclosure are not necessarily to the same embodiment, and such references mean at least one.

FIG. 1 shows a simplified representation of a clustered system coupled to client computers through a network according one embodiment of the invention.

FIG. 2 shows a block diagram illustrating internal components of instances and central node contained within a clustered system according to one embodiment of the invention.

FIG. 3 shows a block diagram of a cluster runtime environment for monitoring and controlling of processes in a clustered system according to one embodiment of the invention.

FIG. 4 shows a flowchart diagram illustrating operations of monitoring and controlling processes in a clustered system according to one embodiment of the invention.

### DETAILED DESCRIPTION

In the following description, specific details are set forth. However, it is understood that embodiments of the invention may be practiced without these specific details. In other instances, well-known hardware and software components, structures, techniques and methods have not been shown in detail to avoid obscuring the understanding of this description.

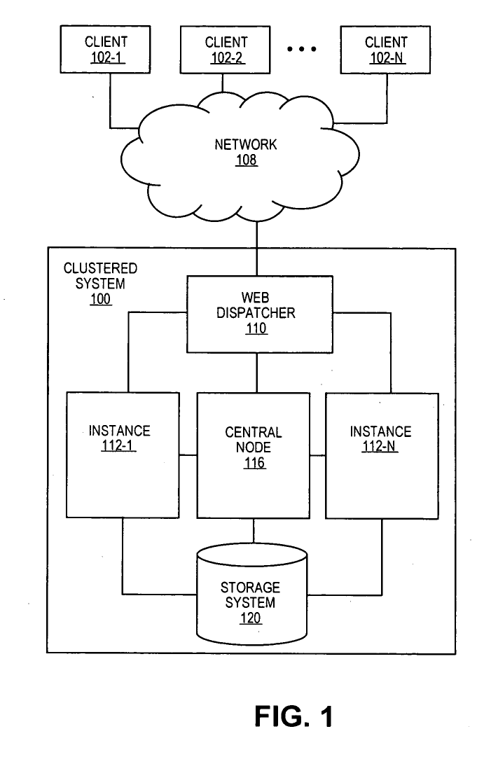

Illustrated in FIG. 1 is an example of a clustered system 100 in which embodiments of the invention may be implemented. The clustered system 100 is coupled to client computers 102-1 through 102-N via a network 108. The network 108 includes, but is not limited to, a local area network, a wide area network, the Internet, or any combination thereof. The network 108 may employ any type of wired or wireless communication channels capable of establishing communication between computing devices.

As shown in FIG. 1, the clustered system 100 includes a set of instances 112-1 through 112-N, which may communicate with each other through the central node 116. The central node 116 is also used to monitor and control processes executed by the instances 112. Each instances 112-1 through 112-N includes one or more server nodes. The instances 112-1 and 112-N are also coupled to a storage system 120. The storage systems 118, 120 provide storage for code and data that are used by the instances 112-1 through 112-N.

The clustered system 100 may be used to provide a scalable server environment that permits substantially real-time access to information for a distributed user base. Accordingly, in one embodiment, a dispatcher 110 is coupled between the network 108 and the instances 112-1 through 112-N to distribute requests from client computers 102 based on the load on the respective instances 112-1 through 112-N. The dispatcher may be, for example, a web dispatcher coupled to network 108 and web server nodes.

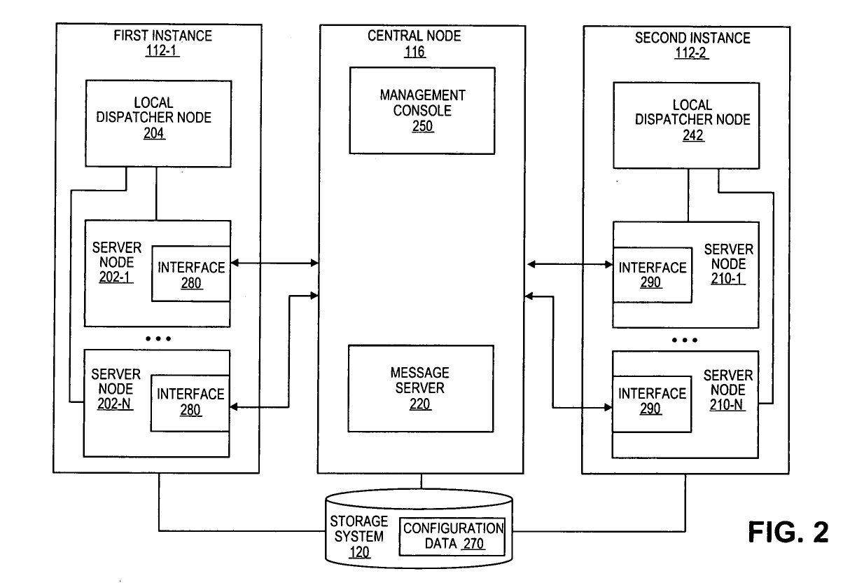

FIG. 2 shows internal components of instances 112-1 and 112-2 and a central node 116 according to one embodiment of the invention. The first instance 112-1 includes a number of server nodes 201-1 through 201-N and a local dispatcher node 204, which receives requests from client computers and dispatches the requests across the multiple server nodes 202. Similarly, the second instance 112-2 includes a number of server nodes 210-1 through 210-N and a local dispatcher node 242, which dispatches requests from client computers across the multiple server nodes 210. In one embodiment, the server nodes implement a Java platform, such as a Java 2 Platform Enterprise Edition (“J2EE”). A J2EE is a Java platform that can be used to develop, deploy and maintain enterprise applications.

Also illustrated in FIG. 2 is a central node 116 coupled between the first instance 112-1 and the second instance 112-2. The central node 116 includes a management console 250 to enable a user at the management console to monitor and control various processes executed by the server nodes 202, 210. Although the management console 250 is shown in the embodiment of FIG. 2 as being included within the central node 116, the management console may be implemented on a client computer system to enable a user at the client computer system to monitor and control various processes executed by the server nodes 202, 210. Also included in the central node 116 is a message server 220 to enable a remotely located server to communicate with the CMAC unit 260 to monitor and control processes running in the clustered system.

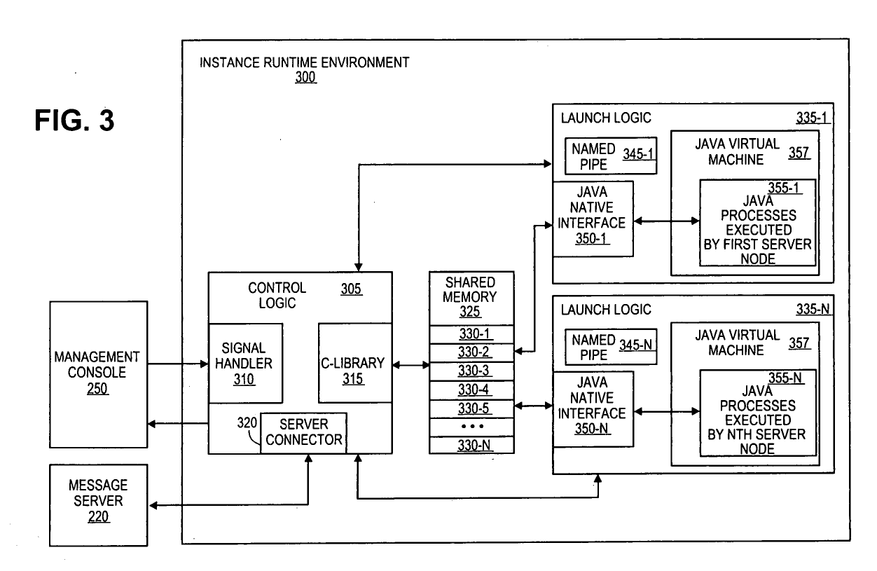

FIG. 3 illustrates an instance runtime environment 300 for monitoring and controlling of processes (e.g., Java processes) executed within an instance of a clustered system according to one embodiment of the invention. Control logic 305 starts an instance by initiating a launch logic 335-1 through 335-N for each server node contained within the instance. In one embodiment, the control logic 305 and the launch logic 335 are responsible for monitoring and managing the status (e.g., starting, terminating and restarting) of the Java processes running within the instance. In one embodiment, an instance is installed and runs on one hardware system. There may be one or more processes, which belong to the instance. Processes such as dispatcher and server nodes are started by the launch logic 335.

The launch logic 335 is responsible for starting a Java program or a set of Java programs. In one embodiment, this is accomplished by loading a Java virtual machine 357 and executing the processes in the Java virtual machine. The executed processes may be used to provide services to client devices. The programs created using Java may attain portability through the use of a Java virtual machine. A Java virtual machine is a software layer that provides an interface between compiled Java binary code and the hardware platform which actually performs the program instructions. In one embodiment, the launch logic 335 is also configured to support the execution of standalone Java programs, which may be executed without loading a Java virtual machine.

To enable the control logic 305 to communicate with the launch logic 335-1 through 335-N, a communication interface mechanism 325 is set up during the start up of the clustered system. The communication interface mechanism 325 may be based on any suitable communication mechanism such as shared memory, pipes, queues, signals, etc. In one embodiment, the shared memory 325 having a number of entries 330-1 through 330-N is set up to provide a way to exchange information between the Java processes 355-1 through 355-N initiated by the launch logic 335 and the control logic 305. In one embodiment, the shared memory 325 is used to store information relating to the status of processes 355-1 through 355-N executed by the server nodes.

The launch logic 335 is configured to obtain information regarding a status of each of the Java processes 355 running in the virtual machine 357 and enable the control logic 305 to access the status information via the shared memory 325. In one embodiment, the status information is obtained by using a Java native interface (JNI) 350 implemented within the launch logic 335. The JNI 350 enables the Java processes 355 running inside the Java virtual machine 357 to execute Java native functionalities that are written and compiled for the underlying hardware platform. The Java native processes are created using Java native programming language, such as C and C++. During runtime, the JNI 350 is invoked by the launch logic 335 to communicate with the Java processes 355 to update the shared memory 325 with information relating to the status of the Java processes 355 running inside the Java virtual machine.

In one embodiment, a list of all pending processes executing on the server nodes and information relating to the status of each process are maintained by the shared memory 325. Accordingly, the control logic can remotely monitor the status of all processes in the instance by accessing the shared memory 325. The control logic 305 may establish a communication with the shared memory 325 via a suitable communication interface 315, such as, for example, C-library 315.

Based on the status information, the control logic 305 may control the operations of processes running within the instance by sending instructions to the launch logic 335 to, for example, start, terminate or restart a particular process. In one embodiment, the instructions to initiate the starting, terminating or restarting of a process or a server node is communicated via a suitable communication interface, such as named pipes 345-1 through 345-N. In response to the instructions received via the named pipes 345, the launch logic 335 controls the operation of the corresponding process running in the virtual machine 357 via the Java native interface 350.

The control logic 305 also includes a communication interface mechanism for establishing a communication with a management console 250. In one embodiment, a signal handler 310 is incorporated within the control logic 305 to receive and interpret signals from the management console. In this regard, the control logic 305 implementing the signal handler 310 enables a user to monitor and control various processes executed in the clustered system from a management console 250. During runtime, the management console 250 may be used to send a signal or a request to control a particular process running on a particular server node. For example, a signal received by the signal handler 310 may be sent by the management console 250 to [1] initiate a soft shutdown, [2] to initiate a hard shutdown, [3] increment the trace level or [4] decrement the trace level.

Also incorporated within the control logic 305 is a server connector 320 to enable a connection with an external server, such as a message server 220. In one embodiment, the message server 220 is used to manage communication between any two nodes contained within the clustered system. The control logic 305 in conjunction with the use of the message server 220 enables monitor and control of processes executed in any server node contained within the clustered system from another server.

In one embodiment, the control logic 305 and the launch logic 335 are executed within each instance of the clustered system. This means that the control logic 305 and the launch logic 335 are implemented in the same instance. In one embodiment, the control logic 305 and the launch logic 335 executing on the same instance establish communication with one another via the shared memory 325 and the named pipes 345.

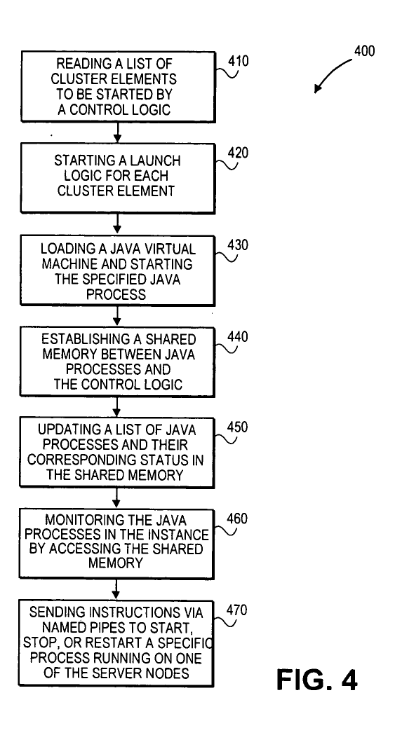

Referring to FIG. 4, the general operations involved in monitoring and controlling of Java processes in a clustered system according to one embodiment of the invention are shown. In block 410, a control logic 305 executing within each instance reads a list of cluster elements (e.g., server nodes) to be started during start up of the clustered system. The list of server nodes to be started may be obtained from a configuration data 270 stored in a storage system 120 (shown in FIG. 2). Then in block 420, the control logic 305 initiates a launch logic 335 for each of the server nodes contained within the corresponding instance. When the launch logic 335 is launched on a particular server node, the launch logic 335 starts a process of constructing an appropriate run-time environment for Java processes by loading a Java virtual machine 357 and starting the specified processes in the virtual machine, in block 430.

At the same time, the control logic 305 sets up a shared memory 325 to provide a means for exchanging information between the Java processes initiated by the launch logic 335 and the control logic 305 in block 440. As indicated above, the shared memory 325 is used to store information relating to the status of processes executing within an instance. The status information stored in the shared memory 325 is periodically updated by the launch logic 335 in block 450. By accessing the updated information contained in the shared memory 325, this enables the control logic 305 to monitor the status of Java processes in the instance, in block 460. Then, in block 470, the control logic 305 sends instructions to a launch logic 335 via a named pipe 345 to start, terminate or restart a particular process running in one of the server nodes.

For example, during runtime, if a process running on a server node of one of the instances fails, the status information of the failed process is obtained by a launch logic via the JNI. The launch logic uses the obtained information to update the shared memory. The status information contained in the shared memory is accessed by the control logic via a communication interface. The control logic recognizes that a failure of a process has occurred based on the status information contained in the shared memory and sends appropriate instructions to enable the same server node or a different server node to assume the operation of the failed process. The instructions to terminate and restart the failed process may be generated automatically by the control logic upon detection of a process failure. Alternatively, the instructions to terminate and restart the failed process may be generated based on a request received from a management console or from a remote server. Once the instructions to terminate or restart a process has been received from the control logic, the launch logic will control the operations of the corresponding process running in the virtual machine via the JNI.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A system comprising:
a cluster having a first instance and a second instance, each of the first and second instances including a plurality of server nodes;
a control logic to start each instance by initiating a launch logic for each of the server nodes, the launch logic, when initiated, to execute Java processes in each respective server node; and
a communication interface coupled between the launch logic and the control logic to enable the launch logic to obtain status of each of the Java processes and enable the control logic to access the status via the communication interface.

2. The system of claim 1, wherein the launch logic is provided to load a virtual machine and execute a Java process in the virtual machine.

3. The system of claim 2, wherein the communication interface comprises:
a shared memory to store the status of the Java processes.

4. The system of claim 3, wherein the launch logic comprises:
a Java native interface to obtain the status of each of the Java processes and to update the shared memory with the obtained status.

5. The system of claim 4, wherein the control logic accesses the shared memory to monitor the status of each of the Java processes.

6. The system of claim 1, wherein the control logic is provided to detect a failure of a Java process and to automatically restart the failed Java process.

7. The system of claim 1, wherein the control logic is provided to generate an instruction to start, terminate or restart a particular process executed server nodes based on a command received from a remote device.

8. The system of claim 1, wherein the communication interface further comprises:
a named pipe to send and receive commands between the control logic and the launch logic.

9. The system of claim 1, wherein the control logic comprises:
a signal handler to receive and interpret signals from a management console.

10. The system of claim 1, wherein the control logic comprises:
a server connector to enable connection with an external server.

11. The system of claim 1, wherein the control logic comprises:
Java native processes.

12. The system of claim 1, wherein the launch logic comprises:
a container combining Java native processes with a Java virtual machine.

13. A method comprising:
executing Java processes for a plurality of server nodes in an instance;
obtaining status regarding the Java processes executed by the server nodes in the instance;
storing the status regarding the Java processes in a communication interface;
accessing the status in the communication interface.

14. The method of claim 13, further comprising:
enabling control of the Java processes based on an instruction received from a remote device.

15. The method of claim 13, further comprising:
using a Java native interface to obtain the status regarding the Java processes.

16. The method of claim 13, further comprising:
detecting a failure of a process within the cluster by accessing the status in the communication interface; and
restarting the failed process.

17. A machine-readable medium that provides instructions, which when executed by a processor cause the processor to perform operations comprising:
executing Java processes for a plurality of server nodes in an instance;
obtaining status regarding each of the Java processes executed by the server nodes in the instance; and
storing the status regarding the Java processes into a shared memory.

18. The machine-readable medium of claim 17, wherein the operations performed by the processor further comprise:
invoking a Java native interface to obtain the status regarding the Java processes.

19. The machine-readable medium of claim 17, wherein the operations performed by the processor further comprise:
receiving instructions via a communication interface; and
starting, terminating or restarting a process based on the instructions received via the communication interface.

20. The machine-readable medium of claim 17, wherein the operations further comprise:
detecting a failure of a process within the cluster by accessing the status in the shared memory and automatically restarting the failed process.

21. An apparatus comprising:
a cluster having a first instance and a second instance, each of the first and second instances including a plurality of server nodes;
a control logic to start each respective instance by initiating a launch logic for each respective server node in the first and second instances;
the launch logic, for each respective server node in the first and second instances, to further launch Java processes, and obtain a status of the Java processes; and
the control logic to access the status obtained by the launch logic.

22. The apparatus of claim 21, further comprising:
a shared memory to enable exchange of information between the Java processes and the control logic.

23. The apparatus of claim 21, wherein the launch logic loads a virtual machine and executes Java processes.

24. The apparatus of claim 23, wherein the launch logic uses a Java native interface to obtain a status of each of the Java processes, and updates information contained in the shared memory based on the status obtained by the Java native interface.

25. The apparatus of claim 21, wherein the control logic detects a failure of a process within the cluster; and automatically restarts operations of the failed process.

26. The apparatus of claim 21, further comprising:
a signal handler to receive a command from a remote device and controlling one of the Java processes based on the command received from the remote device.

27. The apparatus of claim 21, further comprising:
a named pipe to send and receive commands between the control logic and the launch logic.

28. A system comprising:
a cluster having a first instance and a second instance, each of the first and second instances including a plurality of server nodes;
means for starting each instance by executing Java processes in each respective server node; and
means for enabling exchange of information between the Java processes and the means for starting each instance.

29. The system of claim 28, further comprising:
means for loading a virtual machine and execute a Java process in the virtual machine.

30. The system of claim 28, wherein the means for enabling exchange of information comprises:
a shared memory having a plurality of entries.

31. The system of claim 30, further comprising:
means for obtaining status for each of the Java processes; and
means for updating the shared memory with the obtained status.

32. The system of claim 31, further comprising:
means for accessing the shared memory to monitor the status of each of the Java processes; and
means for sending an instruction to the launch means to start, terminate or restart a particular process executed in the cluster.

33. The system of claim 28, further comprising:
means for enabling a user to monitor and control the Java processes running in the cluster from a management console coupled to the means for controlling; and
means for enabling a connection with an external server.
